(19) United States
(12) Patent Application Publication
(10) Pub. No.: US 2005/0116027 A1
(43) Pub. Date: Jun. 2, 2005

(54) Personalized presentation instrument production systems and methods

(75) Inventors: Ken Algiene, Littleton, CO (US); Layne David Beemer, Blair, NE (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: First Data Corp., Englewood, CO (US)

(21) Appl. No.: 10/988,006

(22) Filed: Nov. 12, 2004

Related U.S. Application Data
(63) Continuation-in-part of application No. 10/461,203, filed on Jun. 12, 2003.

(51) Int. Cl. G06K 5/00

(52) U.S. Cl. 235/380

(57) ABSTRACT

In one embodiment, a method for producing a customized presentation instrument comprises receiving at a production computer system production information needed to produce a customized presentation instrument. The production information may comprise customized design information from a purchaser of the presentation instrument, recipient information and a unique identifier. The design information is placed onto a piece of stock material to form the customized presentation instrument. The identifier is stored on the presentation instrument. Further, the completed presentation instrument is sent to the recipient.

### CROSS-REFERENCE TO RELATED APPLICATIONS

This application is a continuation-in-part application of copending U.S. application Ser. No. 10/461,203, filed Jun. 12, 2003, the complete disclosure of which is herein incorporated by reference.

### BACKGROUND OF THE INVENTION

This invention is related generally to the field of presentation instruments, and in particular to the customization of presentation instruments. More specifically, the invention is related to the creation of personalized or customized presentation instruments.

Presentation instruments are used in a wide variety of transactions. Examples of such presentation instruments include credit cards, stored value cards, debit cards, loyalty cards, library cards, membership cards, and the like. Typically, a consumer is given no choice as to what type of information is provided on the presentation instrument. For example, the information displayed on a credit card is typically controlled by the bank issuing the card. Similarly, stored value cards typically use stock materials that all have the same information, such as the same background color and/or design and a logo of the store. At least one bank (Fleet Bank) is currently offering a credit card that permits a customer to choose from several card stock designs.

Even so, the choices for what is to appear on a presentation are still limited. Further, these appear to be in the sole control of the issuer of the presentation instrument.

### BRIEF SUMMARY OF THE INVENTION

In one embodiment, the invention provides a method for producing customized presentation instruments, such as a stored value cards, credit cards, debit cards, and the like. According to the invention, a host computer system is employed to receive presentation instrument information that comprises customized design information from a purchaser of the presentation instrument, recipient information and, in some cases, payment information. Using this information, a presentation instrument record is created having the presentation instrument information. Also, a unique identifier is associated with the presentation instrument record. The presentation instrument record is credited with a certain value based on the payment information, and in some cases, the presentation instrument record may be credited with a certain value after the presentation instrument is received by a recipient. Further, production information that is needed to produce the presentation instrument is generated and may comprise the design information, the identifier and the recipient information. The production information is transmitted to a production facility computer system for production of the presentation instrument.

Conveniently, the presentation instrument information may be received from a customer computer over a network. In this way, the presentation instrument may be designed from the customer's own computer, a kiosk, or the like. Alternatively, the presentation instrument information may be received from a customer service representative computer over a network. In this manner, a customer may contact a service representative who will design the presentation instrument.

In one aspect, the design information may comprise a digital file of a graphic. For example, the digital file may comprise a picture or a drawing that is in a JPEG or other file format.

After the production information is received at the production facility, it may be used to produce the design information and the unique identifier on the presentation instrument. As one example, the design information may comprise a photograph that is printed onto a stock material.

A variety of techniques may be used to store the identifier on the presentation instrument. For example, the identifier may be stored on a magnetic stripe, in a bar code format, on a microchip, on a radio frequency device, using embossing, and the like.

Optionally, activation information may be associated with the presentation instrument record. In this way, the presentation instrument may be mailed or delivered in an inactive state. The presentation instrument remains inactive until the activation information is received. This may be for example, the telephone number of the recipient and may be detected when the recipient calls a call center from a phone associated with the phone number.

In some cases, the method may further involve printing an insert with the recipient information and placing the presentation instrument and the insert into an envelope. Following placement into the envelope, the envelope may be mailed to the recipient.

Once the presentation instrument has been received (and optionally activated) it may be used to purchase a variety of goods or services. This may be accomplished, for example, by providing the presentation instrument to a retailer in connection with the purchase of an item where the identifier is transmitted to the host computer system along with a payment amount. The presentation instrument record may then be debited by the payment amount. Conveniently, the identifier may be read from the presentation instrument using a point of sale device, a bar bode reader or the like.

In another embodiment, the invention provides a presentation instrument production system that comprises a presentation instrument production machine and a production computer system that is coupled to the production machine. The computer system has presentation instrument production information that comprises customized design information from a purchaser of a presentation instrument that is unique to the presentation instrument and an identifier that is unique to the presentation instrument. The system further includes at least one piece of stock material from which the presentation instrument is to be produced. Further, the production machine is configured to apply the design information to the stock material and to record the unique identifier on the stock material to produce a customized presentation instrument having the customized design information and the unique identifier.

In one aspect, the computer system further includes mailing information for a recipient of the presentation instrument. A printer may also be used to print an insert having the mailing information. Conveniently, an inserter machine may be used to associate the presentation instrument with the insert and to place the presentation instrument and the insert within an envelope.

The system may further include a host computer system that is in communication with the production computer system. The host computer system may be configured to produce a presentation instrument record that includes the design information, the unique identifier, payment information and recipient information. In this way, the host computer system may be used to transmit the design information, the identifier and the recipient information to the production computer system to permit the presentation instrument to be produced and mailed to the recipient. The host computer system may also be used to credit the presentation instrument record by at least a portion of a payment amount, and to optionally receive and associate activation information with the presentation instrument record. The payment information may be provided before or after the presentation instrument is produced and delivered to the recipient.

In one particular embodiment, the invention provides an exemplary kiosk that comprises a housing and a display screen that is coupled to the housing. A processor is disposed in the housing, and an input interface is used for inputting information that is usable by the processor. The kiosk also includes an output interface for transmitting information from the processor over a communication network. In one particular arrangement, the input interface is configured to receive a digital image and to receive a request to produce a presentation instrument used in financial transactions. This presentation instrument is to be customized to include the digital image. Also, the processor is configured to cause a presentation instrument request having the digital image to be transmitted from the output interface.

In one aspect, the input interface comprises a touch panel of the display screen and a port for receiving a memory device that stores the digital image. In this way, digital images from a camera may easily be input into the kiosk. In another aspect, the processor is configured to produce on the display screen an option to produce a personalized presentation instrument using a digital photograph. This option is selectable by touching an icon on the touch panel. Another type of input device is a keypad.

In a further aspect, the processor is configured to produce on the display screen a request to input recipient information regarding a recipient of the presentation instrument. This information may include a mailing address of the recipient. Also, the display screen may be configured to display a plurality of digital images, and the processor may be configured to provide an option on the display screen for selecting one of the images, or in some cases multiple images that are to be placed onto the presentation instrument.

The kiosk may also include a reader for reading account information from a payment vehicle. Suitable readers include bar code readers, magnetic stripe readers, OCR readers, smart card readers, RF readers and the like. These may read information from payment vehicles such as credit cards, debit cards, stored value cards and the like.

### BRIEF DESCRIPTION OF THE DRAWINGS

FIG. 1A is a front view of a customized presentation instrument according to the invention.

FIG. 1B is a rear view of the presentation instrument of FIG. 1A.

FIG. 2 is a schematic diagram of one embodiment of a presentation instrument production system according to the invention.

FIG. 3 illustrates one embodiment of a screen display that may be used to select a presentation instrument to customize according to the invention.

FIG. 4 illustrates one embodiment of a screen display that may be used to input purchaser and recipient information when customizing a presentation instrument according to the invention.

FIG. 5 illustrates one embodiment of a screen display that may be used to customize a presentation instrument according to the invention.

FIG. 6 is a flow chart illustrating one method for customizing a presentation instrument according to the invention.

FIG. 7 illustrates one embodiment of a kiosk that may be used to design a customized presentation instrument according to the invention.

### DETAILED DESCRIPTION OF THE INVENTION

The invention provides for the customization or personalization of presentation instruments. In this way, a purchaser may design the look of a presentation instrument. Such a presentation instrument may be for the purchaser's own use, or it may be delivered to a recipient.

The invention may be used to personalize or customize a wide variety of presentation instruments having information that is stored in a wide variety of formats. Examples of presentation instruments that may be used include gift cards, stored value cards, smart cards, credit cards, debit cards, ATM cards, check guarantee cards, loyalty cards, grocery store discount cards, library cards, licenses, travel cards (including airline cards, hotel cars, car rental cards) and the like. Depending on their use, such presentation instruments typically include at least one identifier that is stored in some type of format that may be used to associate an electronic record with the identifier. Examples of formats that may be used to store this and other information on the card include bar codes, magnetic stripes, embossing, radio frequency devices, micro chips, printing and the like. Examples of identifiers include, account numbers, credit card numbers, checking account numbers, and the like.

The presentation instruments may be customized or personalized to include essentially any type of information or design desired by the purchaser. For example, the purchaser may design the presentation instrument to have photographs, pictures, graphics, and the like. These may be provided directly from the purchaser or selected from a library. Other design information that may be used include text and other characters that may be provided in any type and/or size of font. Further, the designs may be of any color. Also, the presentation instruments may be provided with different textures, shapes and the like.

The design information may be provided by the purchaser in a wide variety of formats. For example, the design information may be transmitted in digital form, in a wide variety of formats, such a in a JPEG format, a MPEG format, a text file, a PDF file, a CAD file, in a TIFF format, in a web format, and the like. Alternatively, the design information may be delivery in a hard copy format, such as in an actual photograph, on paper, cardstock, or the like. Such information may then be converted to a computer readable format, such as by scanning a document.

Further, a wide variety of interfaces and devices may be used to transmit the design information from the purchaser. For example, a purchaser may design the look of a presentation instrument on a personal computer, hand held device, kiosk, or the like using any type of graphic design or word processing software. The file may then be electronically transmitted to a host computer system over any type of network known in the art. As another option, a computing device may be used to access a web site where appropriate design software may be downloaded to the local device, or the design may be created while logged into the web site, e.g., the design software may reside on the web server computer. If a computing device is not available, design information may be mailed, faxed or otherwise transmitted to a customer service representative where the information may be scanned in to a computer and modified to an appropriate format. As another option, a user may simply telephone a customer service representative and verbally explain the design he would like.

In addition to the design information, various other information may be solicited or required for the transaction. For example, various kinds of information on the purchaser may be elicited including name, address, payment information, contact information and the like. Delivery information may also be provided indicating where the presentation instrument is to be delivered after being designed. If the recipient is someone other than the sender, information on the recipient may also be provided, such as name, mailing address, and the like. If security features are to be associated with the presentation instrument, this information, such as a PIN or phone number, may be provided as well. In this way, the presentation instrument may be delivered in an inactive state. Upon receipt of the presentation instrument, the recipient may call a number or go to a web site and provide the activation information. One easy way to accomplish this is by having the sender provide the recipient's home phone number. Instructions with the presentation instrument may request the recipient to call a number from his or her home phone in order to activate the presentation instrument. A caller ID system may then be used to automatically detect the caller's home phone number and to activate the account associated with the presentation instrument.

The payment for producing the presentation instrument (as well as the payment of a value that may be associated with a stored value card) may be made in a variety of ways. For example, payment may be made using a credit card, a debit card, a checking account, a transfer of stored value, a money order, using cash, or the like. Further, the payment information may be transmitted over a computer network, over the phone, using a kiosk, or the like.

A wide variety of materials may be used to construct the presentation instruments. For example, the presentation instruments may be constructed from stock materials, such as plastics, card stock, paper, laminates, and the like. Depending on the stock material used to construct the presentation instrument, a wide variety of techniques may be used to place the design information onto the stock material. For instance, the design information may be printed on the stock material (such as by using a laser or ink jet printer). Other examples include silk screening, use of stickers or labels, embossing, painting and the like. In some cases, the stock material may have some information already included, such as the a company logo, legal notices, and the like, or this information may be placed onto the stock material at the time the design information is placed onto the stock material.

In addition to providing the design information on the presentation instrument, some or all of the design information may be placed onto other materials as well. For example, the design information may be provided on any inserts mailed with the presentation instrument, separate special occasion cards (such as traditional paper greeting cards), the envelope or mailer, and the like.

A wide variety of techniques may be used to deliver the presentation instruments to recipients after they have been created. For example, they could be attached to a card carrier and placed into a mailer along with any other inserts as described generally in copending U.S. application Ser. No. 10/028449, filed Feb. 19, 2001, the complete disclosure of which is herein incorporated by reference. This may then be mailed to the recipient. Other techniques include personal delivery, by a courier services, by in-store pick-up and the like. The presentation instruments may also be produced at the purchase location. For example, a kiosk, computer or other interface may be provided within a store to design the presentation instrument. This data may then be transmitted to production equipment located within the store. In this way, after the presentation instrument has been designed, it may be produced and provided to the purchaser at the time of sale. This could be done using a kiosk, a photo or picture booth, in a back room (and picked up at a service counter) and the like. Such equipment may include a printer and a dispensing mechanism to permit the presentation instrument to be printed and then provided to the purchaser.

In some cases, the presentation instrument may be in an inactive state until activated by the recipient. In this way, if the presentation instrument is intercepted or stolen before reaching the recipient, it may not be used. One way to activate the presentation instrument is to require certain information to be supplied by the recipient. This information may be input by the purchaser and then transmitted to the recipient, such as by e-mail, by a phone call, by a separate mailing, or the like. One convenient way is by requiring the recipient to provide his or her phone number to activate the account. By providing a call in number, the recipient may call the number from their home phone (or other designated phone). Software may then be used to detect the calling phone number and to activate the account in the event that it is the same as the number on file.

The presentation instruments of the invention may be used in a wide variety of transactions as known in the art. For example, they may be used in traditional credit card or debit card transactions, such as by reading the account information using a point of sale device, such as the devices described in copending U.S. application Ser. No. 10/116735, filed Apr. 3, 2002, the complete disclosure of which is herein incorporated by reference. They may also be used as gift cards where the value is stored in a host computer system as described generally in copending U.S. application Ser. Nos. 09/971303, filed Oct. 3, 2001; 10/268040, filed Oct. 8, 2002; 10/286006, filed Nov. 1, 2002; 10/405043, filed Mar. 31, 2003; and 10/421604, filed Apr. 22, 2003, the complete disclosures of which are herein incorporated by reference.

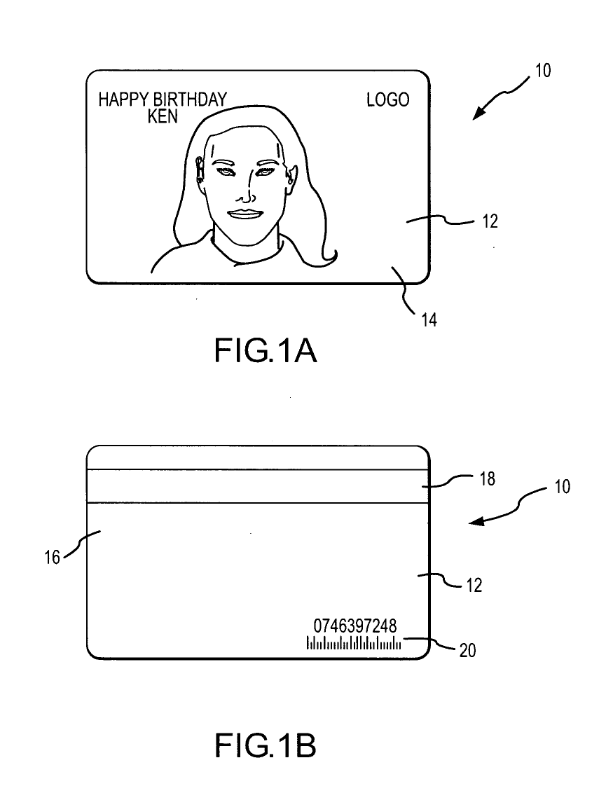

Referring now to FIGS. 1A and 1B, one embodiment of a customized presentation instrument 10 will be described. Presentation instrument 10 is constructed of a stock material 12, which may conveniently comprise plastic, card stock, paper, or the like and may be of any size or shape. Presentation instrument 10 has a front side 14 (FIG. 1A) and a back side 16 (FIG. 1B). Either side may be provided with a unique identifier that may be stored on a magnetic strip 18, in a bar code format 20, or other storage means, such as a microchip, alphanumeric characters, embossing or the like. This identifier may be used in facilitating a transaction as is known in the art. Either and/or both sides may also include customized design information. As shown, front side 14 includes a photograph of a purchaser of the presentation instrument along with a message. In this way, presentation instrument 10 has a unique design, and one that is chosen by the purchaser of the presentation instrument. Other design information that may be provided on front side 14 or back side 16 includes photographs, art work, patterns, text, and essentially any other information desired by the purchaser. Further, the issuer of the presentation instrument may include other information, such as a logo, a standard background design or color, legal disclaimers, methods of use, and the like. The presentation instrument may also include one or more disclaimers. For example, the presentation instrument may indicate that the design information is not associated with the institution issuing the presentation instrument.

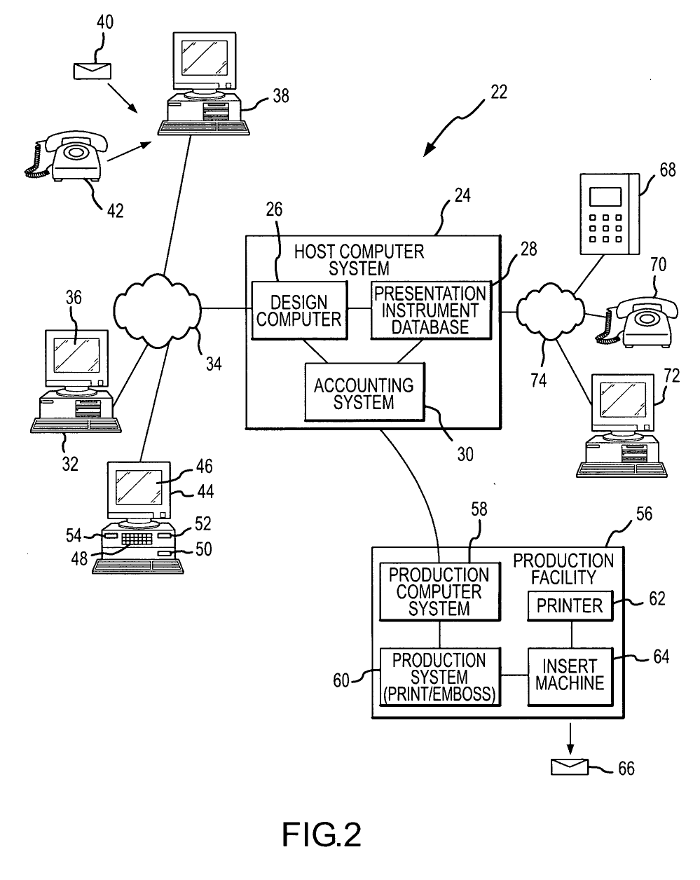

Shown in FIG. 2 is a schematic diagram of a system 22 that may be used to design and produce a customized presentation instrument. System 22 includes a host computer system 24 that in turn includes a design computer system 26 that may be used to facilitate the design of a presentation instrument. System 22 further includes a presentation instrument database 28 having information relating to each presentation instrument. Such information may include, for example, information on the purchaser, information on the recipient, presentation instrument identifiers, values associated with the identifiers, delivery information, activation and security information and the like. For instance, database 28 may be constructed in a manner similar to databases used to store and process stored value cards, such as the one operated by First Data Corporation. Database 28 may alternatively comprise processing systems used in processing credit card transactions, debit card transactions and other financial transactions.

System 24 may also include an accounting system 30 that performs the necessary accounting functions as funds are associated with a presentation instrument or purchases are made. For example, if the presentation instrument is a stored value instrument, accounting system 30 may be used to debit the account when a purchase is made and to credit a retailer's account. In cases where the presentation instrument is a credit card, accounting system 30 may encompass a settlement system used with existing credit cards, such as by using VISA or MASTERCARD, along with other processing systems operated in behalf of the merchant banks and the acquiring banks in order to facilitate payment and settlement. For ATM cards, an interchange network, such as NYCE or STAR may be used.

A variety of interfaces may be used to access design computer 26 when designing a presentation instrument. For example, one way is by using a personal computing device 32 that communicates over a network 34. Device 32 may be any type of computing device, such as a desk top computer, a lap top computer, a PDA, a cell phone, or the like. Further, network 34 may be any type of network, such as the phone network, the Internet, a wireless network, a local area network, or the like. Device 32 includes a display screen 36 to permit various screen displays to be presented to the designer in order to facilitate the design of a presentation instrument. Device 32 may also include one or more input devices are known in the art.

When designing a presentation instrument, the software used to facilitate the design process may be resident on computing device 32, or design computer 26, or both. For example, design software may be running on device 32 and used to completely design the presentation instrument. A file having the design may then be transmitted to design computer 26. Alternatively, design computer 26 may be a web server computer and device 32 may have a web browser. In this way, the design software may be run on design computer 26, with device 32 used for inputs. Payment information, such as a credit card number, a bank account number or the like may also be input and used to pay for the presentation instrument.

In cases where the designer/purchaser of the presentation instrument does not own or have access to a computing device, they may still access design computer 26 using a customer service system. This may be a physical person, a voice response unit, or the like. For example, a computing device 38 may be manned by a customer service representative that may take orders by mail 40, by telephone 42 or the like. For instance, the purchaser may send a mail package containing a hand sketched design, photographs, other artwork, or the like, with a request for the customer service representative to design the presentation instrument. A similar process may take place during a telephone conversation.

As another option, a self manned kiosk 44 may be used to design a presentation instrument. Kiosk 44 may include its own design software so that a presentation instrument may be fully designed with at the kiosk. Kiosk 44 has a display screen 46 and a keyboard 48 that may be used to input information. One advantage of using kiosk 44 is that payment information may be input as well. For example, a cash or check may be deposited into a deposit port 50 and used as payment for the presentation instrument. A card slot 52 is also included for entering a credit card, debit card, or the like which may also be used as a form a payment. Further, payments may be made for the user's bank account. A printer 54 may also be used to print a receipt, a depiction of the presentation instrument that is being designed, and the like.

In some cases, a system may be used to insure that the design information is proper or appropriate before being approved. Content monitoring may be done through software or by a quality assurance individual according to specified guidelines provided to the purchaser. For example, if a design included an inappropriate photograph or inappropriate language, the quality assurance individual could send a message indicating that the particular design is not appropriate and request that another be submitted.

Once host computer system 24 has received the necessary design information, payment information and recipient information, production information may be transmitted to a production facility 56 for fulfillment. Production facility 56 includes a production computer system 58 that receives a data file from host computer system 24. At least some of the data is transmitted to a production system 60 that is used to produce the customized presentation instrument. Production system 60 may comprise one or more machines that may be used to produce stock materials, print, emboss, label and the like in order to provide a customized design on the stock material. For example, the stock material may comprise a piece of paper or plastic that is run through a printer having a graphics file received from computer system 58 to produce a customized image on the stock material. Production system 60 may also be used to initialize the presentation instrument. For example, the presentation instrument may be initialized by providing it with a unique identifier that ties it to the record in database 28. This may require electronically storing the information on a magnetic stripe, embossing an account number on the stock material, printing a bar code label, storing information on a computer micro chip, and the like.

Host computer system 24 may also provide production system 60 with other information that is not placed onto the presentation instrument. For example, computer system 24 may generate security information, such as a PIN, that is sent to production system 60 to permit a separate mailer to be generated having the PIN. In this way, when the recipient receives the presentation instrument and the separate mailer, the PIN may be used to either activate the presentation instrument, or to use it when making transactions.

The presentation instrument may conveniently be mounted to a card carrier that may have various information, and may be mailed with one or more inserts. The card carrier and/or inserts may conveniently be printed using a printer 62 that may receive information from computer system 58. Printer 62 may be used to print such information as the recipient's address, any of the design information, a message from the sender, an amount of value associated with the presentation instrument, terms and conditions, directions for use, and the like. As one specific example, printer 62 may be used to print the same image on an envelope or insert that is also produced on the presentation instrument.

The presentation instrument, card carrier and/or any inserts may be combined and placed into a mailer using an insert machine 64. Examples of suitable insert machines are described in copending U.S. application Ser. Nos. 10/045589, filed Nov. 8, 2001 and 10/036653, filed Nov. 8, 2001, the complete disclosures of which are herein incorporated by reference. Once assembled, proper postage may be applied, and a mail unit 66 containing the presentation instrument may be mailed or delivered to the recipient.

Once issued, the presentation instruments may be used in essentially any way known in the art. For example, their identifiers may be read using a point of sale device 68, such as those at most retail establishments. The identifiers may also be provided over the telephone 70, such as when making a mail order purchase, or over a computer 72, such as when making an Internet purchase. The account identifiers may pass through a network 74 to access host computer system 24 to complete the financial or other transaction as is known in the art.

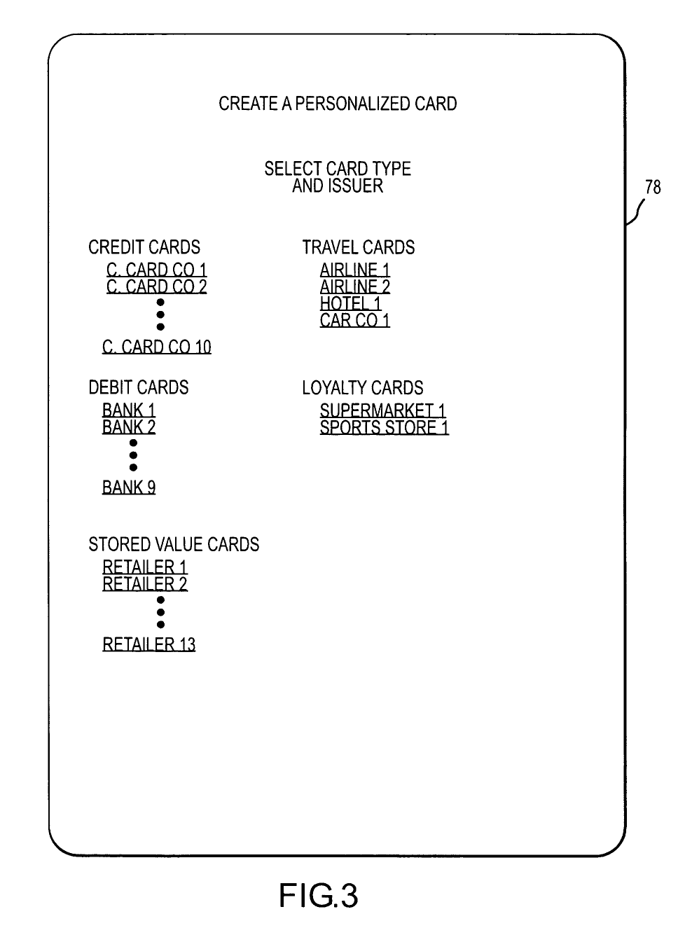

Referring now to FIGS. 3-5, various screen displays will be described that may be used when designing and purchasing a presentation instrument. Shown in FIG. 3 is a screen display screen 78 that may be displayed, for example, on screen 36 (see FIG. 2) when designing a presentation instrument. Screen 78 allows a potential purchaser to select a particular type of presentation instrument and an associated issuer. Conveniently, screen 78 may be viewed using a web browser so that other information may be viewing simply by selecting a hypertext link. Examples of presentation instruments that may be selected include credit cars, debit cards, stored value cards, travel cards, loyalty cards, and the like. Below each one of these categories are listed various specific card types that may be selected. For example, below the credit card heading are listed various credit cards offered from different banks. Selecting one of these will generate another screen that may describe the terms and conditions of the card or give other information. Further, subsequent screens may be displayed to permit the user to personalize the selected presentation instrument.

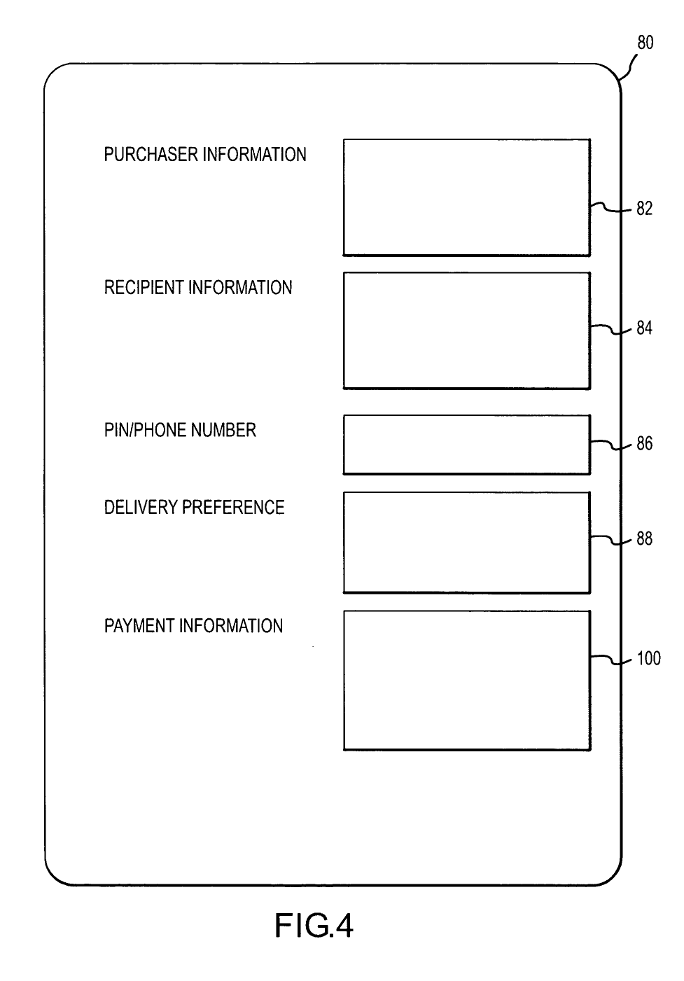

For example, one such Screen Display 80 is illustrated in FIG. 4. Screen Display 80 may be used to elicit information from a potential purchaser of a presentation instrument. Screen Display 80 includes blocks for entering various information needed to pay for the presentation instrument and to send it to a recipient. As shown screen 80 includes a purchaser information block 82 for personal information on the purchaser, such as name, address, phone, and the like. A recipient information block 84 may be used to enter information on the recipient, include name, mailing or delivery address, home phone number, and the like. A PIN/phone number block 86 may be used to receive information on the recipient's home phone number or other personal identification number. This may be used by the recipient to activate the presentation instrument once received. A delivery preference block 88 may be used to indicate a delivery preference for the presentation instrument, such as by regular mail, overnight mail, courier and the like. Further, a payment information block 100 may be used to enter payment information, such as a credit card number, bank account number and the like. In describing display screen 80, it will be appreciated that other formats and screen layouts may be used to facilitate the entry of information as is known in the art. Once entered, this information may be transmitted to the host computer system for storage in a database and may be used to initialize an account. For example, an account identifier may be associated with the data transmitted from the recipient. This account identifier may then be placed onto the presentation instrument when it is fabricated.

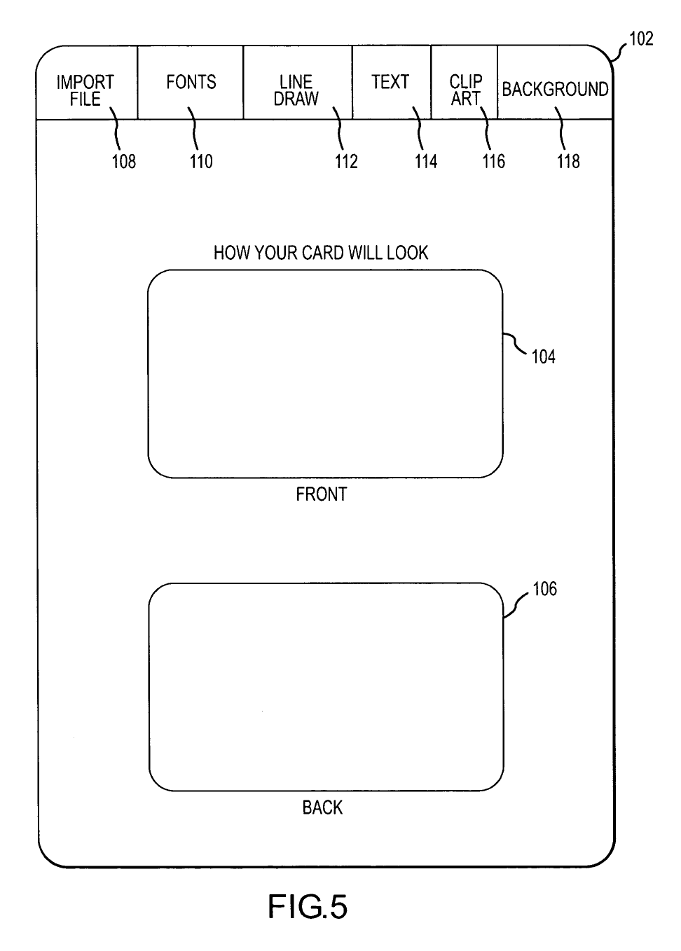

Shown in FIG. 5 is a Screen Display 102 that may be used to design the look of a presentation instrument. Screen Display 102 includes two display sections 104 and 106 that show the front and back side of the presentation instrument as it will look when it is manufactured. As the designer makes changes to the design, it is displayed in sections 104 and 106. Also, various design tools are included for designing the look of the presentation instrument. These may conveniently be displayed in the form of icons on display screen 102. For example, display screen 102 may include an import file icon 108 that may be used to import various files having information to be included on the presentation instrument. Such files may include digital photographs, other digital images, text files, CAD files, and the like. Once imported, these files may be displayed in sections 104 and 106. Their size and location may be adjusted by using a mouse, or other pointing device as is known in the art.

A fonts icon 110 may be used to select various types of fonts and/or colors for the presentation instrument. For example, background colors may be selected as well as fonts and colors for any text. Text messages may be imported from a file or simply typed into sections 104 and 106 using a keyboard or other entry device. Their font or color may be modified by highlighting the text and then selecting the fonts icon 110.

Line draw icon 112 may be used to draw freelance or other lines onto the presentation instrument. As the lines are drawn, they may be displayed in sections 104 and 106. A text icon 114 may be used to enter various textual messages in a manner similar to that previously described. A clip art icon 116 may be used to select various pictures, designs, or the like from a file and then paste them onto the presentation instrument. The clip art may be organized into various categories. For example, some could be occasional and change over time. For instance, there could be clip art for various holidays, social or other reoccurring events (such as secretary appreciation week), seasons, and the like. Further, various art would could be licensed from artists and used as clip art. This could also help to promote the artist's work.

A background icon 118 may be used to select a background image, color or the like for the presentation instrument. Further, it will be appreciated that other types of display screens are possible in order to design the presentation instrument, and it will be appreciated that the invention is not intended to be limited to a specific type of interface for designing a presentation instrument. Once the presentation instrument has been designed, it may be associated with an account identifier and send to the production facility for fulfillment.

As one specific example, an image of a person's business card could be provided to the production facility so that a presentation instrument having the appearance of a business card could be produced. The business card could be scanned and transmitted to the host system, or could simply be mailed to a service center in a manner similar to that described herein. In this way, a business person could use the presentation instrument as a marketing tool. For example, the presentation instrument may be loaded with value that may be used at one or more retailers. The names of the retailers could be provided on the presentation instrument itself, or one could go to a web site having a listing of participating retailers. When handing out a business card (i.e., presentation instrument), the business person could explain that the business card can also be used to make purchases, such as for a beverage at a participating retailer. This provides an incentive to keep the business card and to review it when making a purchase. Further, if desired, the recipient could keep the card and add value to it in a manner similar to that described herein. In addition to business cards, other marketing information could also be used, such as the logo of a particular business, an actual advertisement, and the like. In such cases, a person or a business may want to order multiple presentation instruments having the same design.

As another specific example, the presentation instruments may be used as promotions. For instance, a business could give out presentation instruments (such as when a person visits a store or makes another purchase) that are good at another retail location. In this way, retailers could cross promote their products. For example, an electronics store could provide a presentation instrument that could be used at a video store. The host computer system could include various rules so that if one of the presentation instruments was used at a video store, the video store would receive some type of payment back from the electronics store. These rules could be decided contractually by the various parties and then implemented into the accounting system of the host computer system.

As a further example, the presentation instruments may be used to represent a gift itself. For instance, instead of ordering a gift for someone, a person could order a presentation instrument having the appearance of the gift. The presentation instrument may have a value associated with it that is sufficient to pay for the gift. In this way, the recipient would receive a presentation instrument that could be taken to a location to purchase the item. This may be done for essentially any type of good or service. For example, if the person wanted to give a book, the person could order a presentation instrument with its front side having the same image as the front cover of the book and its back side having the same image as the back cover of the book. The person would then make a payment sufficient to pay for the book. When the recipient received the presentation instrument, it could be taken to a book store and used to purchase the book. Similar techniques could be used to place images of essentially any type of packaging on the presentation instrument so that the presentation instrument would look like the item being purchased. In some cases, the shape of the presentation instrument could be made to have the shape of the associated item. Merely by way of example, presentation instruments could include the images of movies, CD's, clothing, consumer products, sporting goods, and the like. If necessary, the host computer system could also include licensing information that could be used to ensure that the copied images complied with appropriate copyrights, design patents and the like.

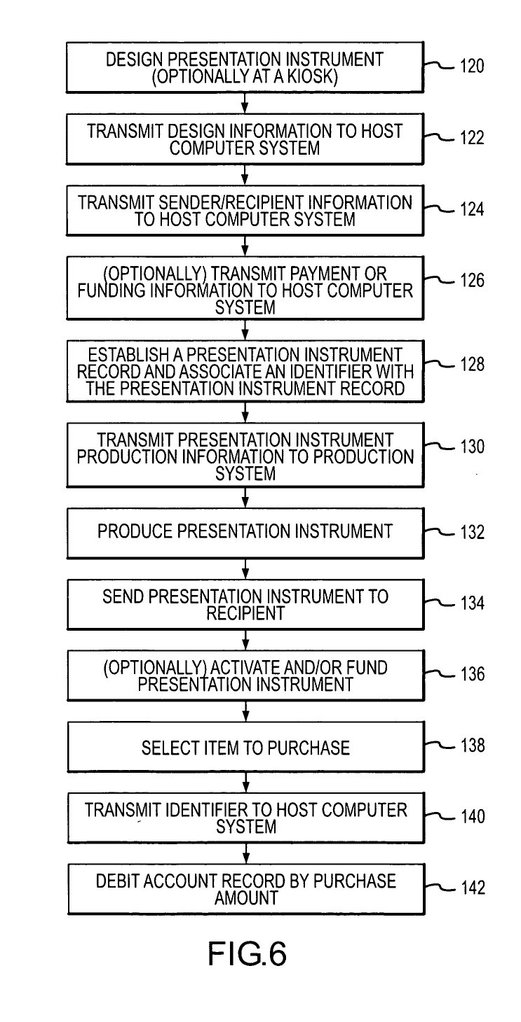

Referring now to FIG. 6, one method for designing and producing a presentation instrument will be described. The process may begin by selecting or creating a design for a presentation instrument as shown in step 120. This may be done using any of the techniques described herein. In one specific embodiment, the design information is input into a kiosk. Design information is transmitted to a host computer system as shown in step 122. Along with the design information, information on the sender and/or recipient is also sent to the host computer system as shown in step 124. Optionally, payment information used to provide payment for the presentation instrument may also be transmitted to the host computer system as shown in step 126. This payment may be to cover the cost of production or to fund an account.

With such information, the host computer system may establish a presentation instrument record and associate an identifier with the presentation instrument record as shown in step 128. The identifier may be for a stored value account, a credit card number, a loyalty system number, a club number or the like.

As shown in step 130, presentation instrument production information is transmitted to a production system in order to produce the customized presentation instrument. With this information, the presentation instrument is produced as shown in step 132. In some cases, several requests may be transmitted in batch mode so that multiple unique presentation instruments may be produced in a single production run. Once produced, the presentation instrument may be sent to the recipient as shown in step 134. Optionally, the presentation instrument could be sent to the purchaser or someone else for personalized delivery to the recipient. In some cases, the presentation instrument may need to be activated and/or funded before it may be used. As shown in step 136, the presentation instrument may be activated prior to use, or funds may be loaded onto an account.

In step 138, the recipient may use the presentation instrument to make a purchase. When performing a stored value transaction, the identifier may be transmitted to the host computer system as shown in step 140, and the associated account may be debited by the purchase amount as shown in step 142. For other types of purchases, the identifier and other transaction information may be processed as is known in the art.

In one specific embodiment, the invention provides a way to customize a presentation instrument using digital photographs or pictures. Such digital photographs may be produced using essentially any type of digital camera, including traditional cameras, cell phone cameras, camcorders and the like. The digital images that are captures may then be stored in essentially any type of storage media, including magnetic media, memory sticks, disks and the like. Once the digital information has been captured and stored it may be transferred to a kiosk, computer or other type of communication device so that the information needed to produce a customized presentation instrument may be transmitted to a production system (which may include a host computer system). In some cases, such as when the digital information is capture in a device having communication capabilities, such as a cell phone or PDA, the digital image could be transmitted directly to the production system.

In the specific case when a kiosk is used to receive the digital information, it may be transferred in a variety of ways. For example, the digital image could be captured in a memory stick that is then interfaced with the kiosk. Other ways to transfer the digital information include by using disks, wirelessly, a USB port and the like. The kiosk may also include a display screen to permit the user to visualize the digital image transferred from the camera. Also, various screen displays may be produced to permit the user to indicate that the image is to be provided on a presentation instrument. For instance, the kiosk could include a touch screen (or other input device such as a key pad) to permit the user to select on option for ordering a customized presentation instrument with the digital image. Other information that may be input from the user includes contact information for a recipient of the presentation instrument so that the presentation instrument may be delivered to the recipient following its production.

The kiosk may also be configured to permit editing of the digital image, such as cropping, enlarging or reducing, so that the digital image may fit on the presentation instrument. The kiosk may also be configured to display an image of the presentation instrument with the digital picture so that the user may be able to visualize the final product before sending it off for production.

In some cases, the user may be charged a fee for producing the presentation instrument. In other cases, such as when the presentation instrument is a gift card or stored value card, the user may choose to fund the card prior to its production. In such cases, the kiosk may be provided with various input devices to permit a payment to be made. For example, payments could be made in cash (such as by including a coin or a bill slot), by using another presentation instrument, such as a credit card, a debit card, stored value card, or the like. In these cases, the kiosk may include an interface for reading account information, such as a magnetic stripe reader, an RF reader, a smart card reader, a bar code reader or the like. The kiosk may be configured to charge or debit the account using techniques known in the 10 art.

Once the presentation instrument having the digital picture is in the desired format, the user may instruct the kiosk to transmit the information to the production system where the presentation instrument may be produced and sent to the recipient similar to other embodiments described herein. Following production, the presentation instrument may be delivered to the recipient. If the presentation instrument is a gift card, it may be funded using any of the techniques described herein. If already funded, the card could be sent out in an inactive state until the recipient contacts a customer service center or automated system to activate the card.

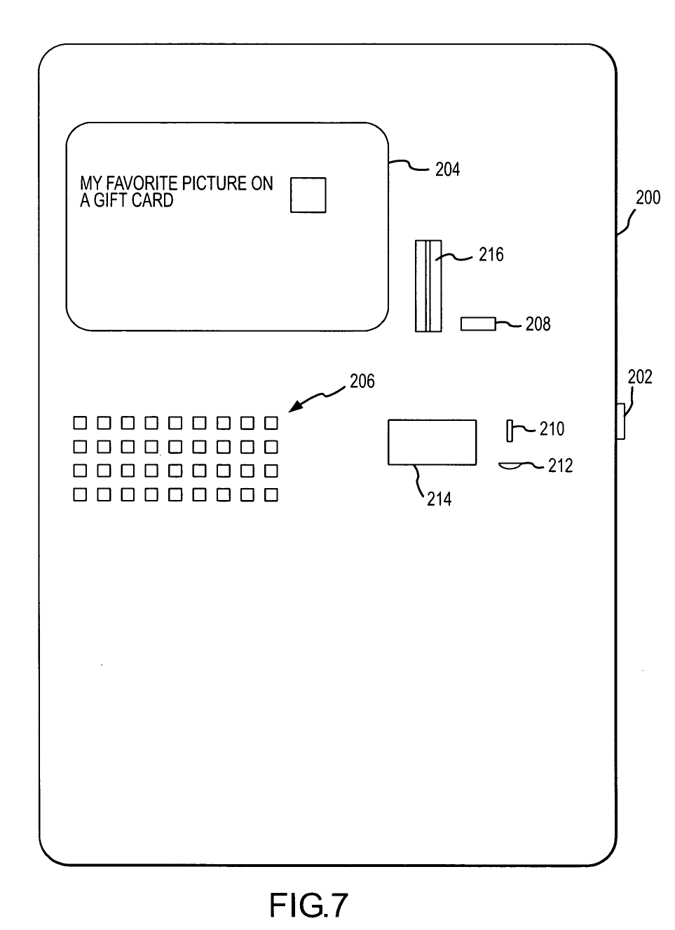

Referring now to FIG. 7, one embodiment of a kiosk 200 that may be used to design and order a personalized presentation instrument using a digital image will be described. Kiosk 200 may be provided with a variety of input and output interfaces. For example, kiosk 200 could include an output interface 202 that is configured to transmit digital information over a variety of communication networks known in the art. Output interface 202 may be used to transmit the digital picture along with other production data to a host computer system so that the customized presentation instrument may be produced. Output interface 202 could also be used to interface with a variety of financial networks, such as credit card networks, ATM or debit card networks, stored value networks and the like. These networks may be used to provide payment for producing a presentation instrument and/or for funding the presentation instrument.

Kiosk 200 also includes a variety of input devices. One type of input interface is a display screen 204 that may also be configured as a touch screen. Kiosk 200 may include one or more processors that are configured to produce various information on display screen 204. In turn, this permits the user to enter various data into kiosk 200. For example, as illustrated in FIG. 7 display screen 204 may be configured to produce a display asking whether the user wishes to produce a gift card with a picture. This option may be selected simply be touching the appropriate location on screen 204. Another way to input information into kiosk 200 is by using a keypad 206, which may include letters, numbers or other alpha numeric characters.

To provide kiosk 200 with one or more digital images, kiosk 200 may include a port 208 for interfacing with some type of memory device having the digital images. Such memory devices could include a memory stick, a disk or the like. Once the digital images have bee input into kiosk 200 they may be displayed on display screen 204 for viewing. Kiosk 200 may be used to produce a request to develop the images, to produce a presentation instrument with one or more of the images, or the like.

If the user selects the option to produce a customized presentation instrument, various information may be needed from the user. For example, the user may need to select the desired image or images to be placed on the presentation instrument, select the size of the image, the location of the image on the presentation instrument, or provide other editing features. The user may also be provided with the chance to input information on the recipient, such as a name and address, desired delivery time or the like. In some cases, the user may need to provide payment for the presentation instrument. This may be a production fee, such as fifty cents or a dollar. In other cases, such as with a gift card or debit card, the user may need to fund the card. In either case, kiosk 200 may be provided with various interfaces for entering payment information. For example, kiosk 200 may include a coin slot 210 with a coin return bin 212. This permits payments to be made with coinage. A bill receiving port 214 may be used for inputting currency. Also, kiosk 200 may include a card reader 216 for reading account information from various payment instruments, such as a magnetic stripe reader, a RF reader, a bar code reader, a smart chip reader or the like. These may be used to read account information from cards, such as credit cards, debit cards, stored value cards and the like as is known in the art.

Hence, using kiosk 200 a user may transmit various digital images into the kiosk's memory and then select and/or edit the images for use on a presentation instrument. Once the presentation instrument has been designed, the user may designate who is to receive the presentation instrument and optionally provide payment information. A file may then be transmitted from kiosk 200 to a production facility system where the presentation instrument is produced with the selected image and then sent to the recipient.

The invention has now been described in detail for purposes of clarity and understanding. However, it will be appreciated that certain changes and modifications may be practiced within the scope of the appended claims.

1. A presentation instrument production system, comprising:
a presentation instrument production machine;
a production computer system coupled to the production machine, the computer system having presentation instrument production information that comprises a digital photograph from a designer of a presentation instrument that is unique to the presentation instrument and an identifier that is unique to the presentation instrument; and
at least one piece of stock material;
wherein the production machine is configured to apply the digital photograph to the stock material and to record the unique identifier on the stock material to produce a customized presentation instrument having the digital photograph and the unique identifier.

2. A system as in claim 1, wherein the computer system further includes mailing information for a recipient of the presentation instrument, and further comprising a printer that is configured to print an insert having the mailing information.

3. A system as in claim 2, further comprising an inserter machine that is configured to associate the presentation instrument with the insert and to place the presentation instrument and the insert within an envelope.

4. A system as in claim 1, further comprising a host computer system that is in communication with the production computer system, wherein the host computer system is configured to produce a presentation instrument record that includes the digital photograph, the unique identifier and recipient information, and to transmit the digital photograph, the identifier and the recipient information to the production computer system.

5. A system as in claim 4, wherein the host computer system is configured to credit the presentation instrument record by at least a portion of a payment amount.

6. A system as in claim 5, further comprising an interactive voice system for receiving payment information used to credit the presentation instrument record.

7. A method for producing a customized presentation instrument, the method comprising:
receiving at a host computer system presentation instrument information that comprises customized design information from a purchaser of the presentation instrument and recipient information;
creating a presentation instrument record having the presentation instrument information;
associating a unique identifier with the presentation instrument record;
generating production information needed to produce the presentation instrument, wherein the production information comprises the design information, the identifier and the recipient information; and
transmitting the production information to a production facility computer system for production of the presentation instrument.

8. A method as in claim 7, wherein the presentation instrument information is received from a kiosk over a network.

9. A method as in claim 7, further comprising sending the presentation instrument to a recipient, and further comprising receiving from the recipient payment information, and crediting the presentation instrument record with a certain value based on the payment information.

10. A method as in claim 7, wherein the design information comprises a digital file of a photograph.

11. A method as in claim 10, wherein the digital file is in a JPEG file format.

12. A method as in claim 7, further comprising producing the design information and the unique identifier on the presentation instrument.

13. A method as in claim 7, wherein the design information comprises a photograph that is printed onto a stock material or information from a business card.

14. A method as in claim 7, further comprising storing the identifier on a magnetic stripe on the presentation instrument.

15. A method as in claim 7, further comprising storing the identifier in a bar code format on the presentation instrument.

16. A method as in claim 7, further comprising electronically storing the identifier on the presentation instrument.

17. A method as in claim 7, further comprising embossing the identifier on the presentation instrument.

18. A method as in claim 9, further comprising receiving and associating activation information with the presentation instrument record.

19. A method as in claim 7, further comprising printing an insert with the recipient information and placing the presentation instrument and the insert into an envelope.

20. A method as in claim 19, further comprising mailing the envelope to the recipient.

21. A method as in claim 18, further comprising providing the host computer system with the activation information to activate the presentation instrument.

22. A method as in claim 9, further comprising providing the presentation instrument in connection with the purchase of an item, and transmitting the identifier to the host computer system along with a payment amount, and debiting the presentation instrument record by the payment amount.

23. A method as in claim 22, further comprising reading the identifier from the presentation instrument using a point of sale device or a bar bode reader.

24. A method for producing a customized presentation instrument, the method comprising:
receiving at a production computer system production information needed to produce a customized presentation instrument, the production information comprising customized design information having an image produced from a digital photograph, recipient information and a unique identifier;
producing the design information onto a piece of stock material to form the customized presentation instrument;
storing the identifier on the presentation instrument; and
sending the presentation instrument to the recipient.

25. A method as in claim 24, further comprising storing the identifier on a magnetic stripe on the presentation instrument or in bar code format.

26. A method as in claim 24, further comprising monitoring the design information for content.

27. A method as in claim 24, further comprising electronically storing the identifier on the presentation instrument.

28. A method as in claim 24, further comprising embossing the identifier on the presentation instrument.

29. A method as in claim 24, further comprising printing an insert with the recipient information and placing the presentation instrument and the insert into an envelope.

30. A method as in claim 30, further comprising mailing the envelope to the recipient.

31. A method as in claim 30, further comprising printing the design information on the insert or the envelope.

32. A kiosk comprising:
a housing;
a display screen coupled to the housing;
a processor disposed in the housing;
an input interface for inputting information that is usable by the processor; and
an output interface for transmitting information from the processor over a communication network;
wherein the input interface is configured to receive a digital image and to receive a request to produce a presentation instrument used in financial transactions having the digital image, and wherein the processor is configured to cause a presentation instrument request having the digital image to be transmitted from the output interface.

33. A kiosk as in claim 32, wherein the input interface comprises a touch panel of the display screen and a port for receiving a memory device that stores the digital image.

34. A kiosk as in claim 33, wherein the processor is configured to produce on the display screen an option to produce a personalized presentation instrument using a digital photograph, and wherein the option is selectable by touching the option on the touch panel.

35. A kiosk as in claim 34, wherein the processor is configured to produce on the display screen a request to input recipient information regarding a recipient of the presentation instrument.

36. A kiosk as in claim 35, wherein the request to input recipient information further includes a mailing address of the recipient.

37. A kiosk as in claim 32, wherein the display screen is configured to display a plurality of digital images, and wherein the processor is configured to provide an option on the display screen for selecting one of the images.

38. A kiosk as in claim 32, further comprising a reader for reading account information from a payment vehicle.

39. A kiosk as in claim 38, wherein the reader is selected from a group consisting of bar code readers, magnetic stripe readers, OCR readers, smart card readers, and RF readers.

40. A kiosk as in claim 32, wherein the input interface comprises a plurality of input keys.
